(19) United States
(12) Patent Application Publication
(10) Pub. No.: US 2011/0005056 A1
(43) Pub. Date: Jan. 13, 2011

(54) METHOD FOR ASSEMBLY OF A PART ON A SUPPORT

(75) Inventors: Christophe GIGANDET, Le Locle (CH); Armin BEHREND, Les Verrieres (CH); Francisco DIAS, Fleurier (CH)

Correspondence Address: YOUNG & THOMPSON, 209 Madison Street, Suite 500, Alexandria, VA, 22314, US

(73) Assignee: CHOPARD TECHNOLOGIES SA, Fleurier (CH)

(21) Appl. No.: 12/833,293

(22) Filed: Jul. 9, 2010

(30) Foreign Application Priority Data
Jul. 10, 2009 (EP) 09165253.7

(51) Int. Cl. B23P 11/00

(52) U.S. Cl. 29/428

(57) ABSTRACT

The present invention relates to a method for assembly of a hard part (12) made in a material the hardness of which is higher than 500 Vickers on a fixed support (10) consisting in being: equipped of a plate (18) in malleable material arranged to be tightly positioned on the support; equipped of a hard part (12) further including a geometrical shut-off element positioned so as to be able to cooperate with the plate; and equipped of a clamping element for sandwiching between the latter and the support, the plate and the hard part.

### TECHNICAL FIELD

The present invention relates to a method for assembly of a part on a support. This method of assembly may also be used as a method to provide a system for positioning the part in relation to the support, and a method of fine tuning of a function.

### STATE OF THE ART

In recent years, the materials used in watchmaking have evolved considerably. Particularly, the growth and etching techniques developed for other branches of microtechnology offer particular opportunities for applications in watchmaking. However, most of these new materials such as silicon or diamond, have no plastic range or have only a small plastic range, that is to say they cannot undergo plastic deformation. The driving out methods commonly used for assembling a part, such as a wheel, on an axis cannot be used because they lead into breaking the part.

Several solutions have been proposed for assembling a wheel on an axis, such as, for example, that described in document EP1850193, implementing an intermediate part, such as a wheel, between the axis and the part without plastic field, for being subjected to mechanical stresses related to driving out.

Conversely, for assemblies of parts without plastic field on a flat support, to the knowledge of the applicant, there is no satisfactory technique adapted to the constraints arising from the use of plastic parts without a plastic field. Indeed, it is difficult to screw such a part directly into a support, because the risks of breakage are high. Such difficulties, more generally, may be met with hard parts made of materials typically having hardness higher than 500 Vickers. Besides silicon and diamond, nickel, steel, ceramics and stones (natural and artificial) are also materials used in watchmaking likely to bring about such problems.

Furthermore, the purpose of this invention, besides providing a convenient solution for attaching a hard part on a flat surface, is also to offer a way for precise tuning of the position of the hard part in relation to the support. In another aspect, the invention may also be used for fine tuning of a function.

### DISCLOSURE OF THE INVENTION

More specifically, the invention relates to various methods of assembly and tuning, as defined in the claims.

### BRIEF DESCRIPTION OF THE DRAWINGS

Other characteristics of this invention will become more evident upon reading the following description, with reference to the accompanying drawings, wherein:

FIG. 1 shows in top view and section side view the various elements used in a first embodiment of the method according to the invention,

FIG. 2 is a section view of an assembly resulting from the implementation of this first embodiment,

FIGS. 3a, 3b and 3c illustrate the aspect of position tuning of the invention,

FIGS. 4, 5 and 6 show alternatives as to the shape of the hard part,

FIG. 7 is a section view of an assembly resulting from the implementation of the alternative shown in FIG. 5,

FIGS. 8, 9 and 10 are respectively section views of an assembly according to an embodiment of the top views of elements used for this embodiment,

FIG. 11 shows a top view of the various elements used according to a second embodiment of the method according to the invention, and

FIG. 12 illustrates the resulting assembly,

FIGS. 13 and 14 provide illustrations of a part and of the implementation of the invention for adjusting the linear position of such a part, and

FIGS. 15 and 16 provide illustrations of a part and of the implementation of the invention for adjusting the circular position of such a part.

### EMBODIMENT(S) OF THE INVENTION

The elements shown in the figures and described below are offered only as general illustration of the principle such as claimed. It is evident that the proposed forms are not exhaustive. Therefore, only the structural aspects useful for understanding the invention shall be described.

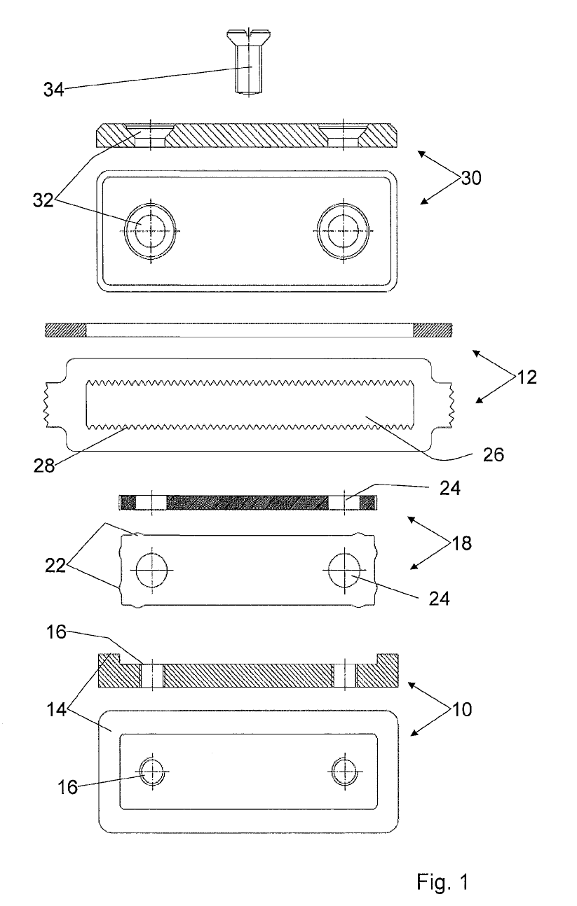

FIG. 1 shows a support 10 on which a hard part 12 is intended to be attached. This support 10 may be any element, in particular an element of the frame of a watchmaking part, such as a plate or a bridge. The support 10 has a rim 14 which defines, with the support surface 10 thereof, a housing of height h. As it will become evident later, other elements may be integrated on the support 10 in implementing the method. According to the illustrated example, the support receives in the bottom of the housing, two tappings 16, directed perpendicular to the bottom surface of the housing.

According to an important aspect of the method according to the invention, a malleable plate 18 is used. The latter may be metallic or synthetic and, possibly, have elastic properties. It is likely to be deformed by cold or hot creep by the application of mechanical stress. A material in paste form, which may be deformed, then stiffened, for example by polymerisation, may also be used. The application of thermal stress is also possible, which, should it be necessary, cause a fusion of the malleable plate. It is possible, for example, to use a plate made of gold, tin, aluminium, rubber, and polymer. The plate 18 is sized in order to be positioned tightly in the housing while defining spaces of deformation 20, shown in FIG. 3a, between the latter and the rim 14. In other words, the plate can be placed in the housing. For example, in the case of a rectangular housing as shown in FIG. 1, the plate 18 has a generally rectangular shape slightly smaller than that of the housing, but occasional bulges 22 extend the surface of the plate resulting in overall dimensions equal to the internal dimensions of the housing. Thus, the bulges 22 allow the creation, between the plate 18 and the rim 14, open spaces, forming deformation spaces 20, the role of which will become evident later. It will be observed that the plate has a thickness e higher than h. With specific reference to the example, the plate has another two passing through orifices 24, positioned opposite the bottom tappings.

For implementing the method according to the invention, it is convenient to have a hard part of which in the drawings is shown only a portion of the attachment. The hard part is made of materials typically having a hardness higher than 500 Vickers, and in particular it may be of silicon, diamond, nickel, steel, ceramic or even in stone (natural or artificial).

The hard part 12 is passed through an oblong opening 26 arranged so that the orifices 24 of plate 18 are positioned opposite the opening. Positioning means are arranged to position the part 12 in relation to the support 10 and the plate 18 so as to leave only one degree of free movement to the hard part 12 in relation to the support 10. Pins or guide elements may, for example, be provided arranged on the support 10 or an element of the frame to which the support is integral.

Furthermore, the hard part 12 has a geometrical shut-off element positioned so as to be able to cooperate with the said plate. More precisely, the geometrical shut-off element is positioned in order to be able to remove the degree of free movement of the hard part. In other words, the geometrical shut-off element has at least one portion substantially orthogonal to the free direction of the hard part. This geometrical shut-off element may be located on the lateral surfaces of the hard part 12 or on the face thereof intended to be in contact with the malleable plate 18.

According to a particular embodiment suggested in the Figures, the geometrical shut-off element consists of a series of identical elements arranged periodically on the circumference of the hard part. In the example given in the drawing, the largest lateral surfaces of the opening have regular toothing. As it will become evident below, such an embodiment allows a movement of the hard part 12 according to its degree of free movement, this movement being indexed depending on the period of the elements. A skilled person in the art will consider various alternatives to achieve periodical elements, in particular elements constituted of several dissimilar portions.

To maintain the various elements, a bearing plate 30 is furthermore provided, intended to enclose, between the latter and the support 10 the malleable plate 18 and the hard plate 12. Typically, the bearing plate 30 is sized substantially equal to that of the support 10 so that they can take support on the rim 14. The bearing plate 30 is equipped with means helping to ensure rigid attachment thereof to the support 10 according to the example, the bearing plate 30 is pierced with two openings 32, positioned opposite the tappings 16 of the bottom of the support and orifices 24 of the plate 18. When the support 10, the malleable plate 18 and the bearing plate 30 are in position, the tappings 16, the orifices 24 and the openings 32 are aligned and allow the insertion of screws 34 for integrating and maintaining the assembly, the screws 34 passing through the opening 26 that includes the hard part 12. It will be observed that the bearing plate 30 will have, preferably, a flat surface on the side intended to provide support and to be directed towards the support 10. More generally, screws, or screw-ups or other clamping elements can tighten directly the hard part and thus sandwich among them and the support 10, the malleable plate 18 and the hard part 12.

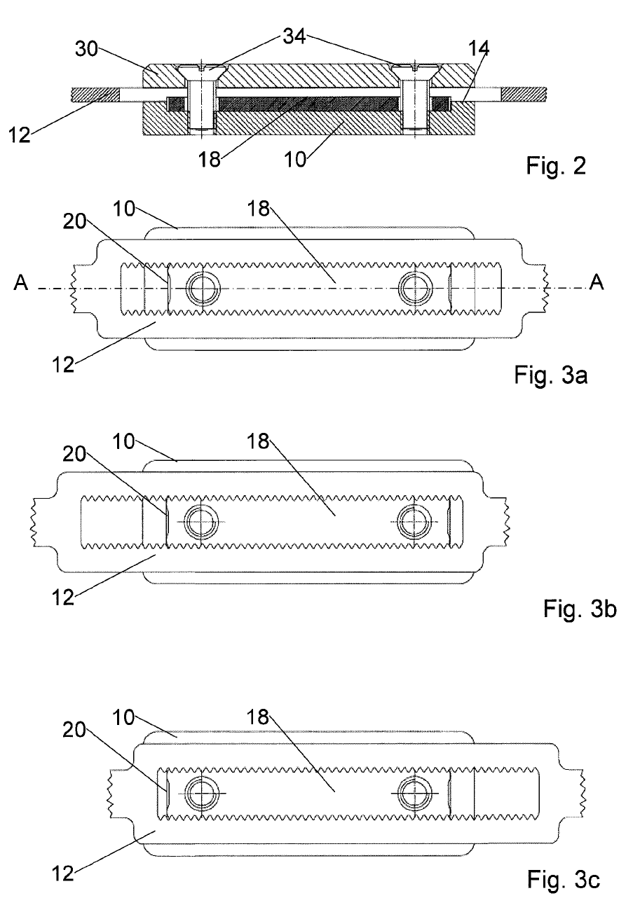

We shall now describe how the above-mentioned different elements are assembled. Firstly, the malleable plate 18 is arranged in the housing of the support 10. Then the hard part 12 is arranged on the plate 18 and is positioned with the positioning means provided for this purpose. At this stage of the assembly, the hard part 12 is free to move, preferably according to a single degree of free movement allowed by the positioning means. Then, the bearing plate 30 is positioned on the hard part 12, the latter being sandwiched between the bearing plate 30 and the support 10 as shown in FIG. 2. The bearing plate 30 and the support 10 are then compressed against each other, until placing the bearing plate 30 in abutment on the rim 14. Thus, the hard part 12 exerts a stress on the malleable plate 18 allowing deforming it plastically so that the geometrical shut-off element of the hard part is encrusted. More specifically, a permanent structure is thus created in the plate 18 with which cooperates tightly the geometrical shut-off element. The plate 18 may be deformed in the deformation spaces 20 in order to limit the stresses and pressure to which it is subjected. Due to the final deformation of the plate 18, the degree of free movement of the hard part is
removed and the latter is thus secured to the support 10. In the particular example of FIGS. 1 and 2, the pressure is exerted by tightening the bearing plate 30 to the support 10. This screwing ensures at the same time the exertion of a constraint providing the deformation of the malleable plate 18 and the fastening of the assembly thus formed.

In this particular embodiment, according to which the geometrical shut-off element consists of a series of identical elements 28, it is advantageous to use the system proposed above for adjusting the position of the hard part 12 in relation to the support 10, as shown in FIGS. 3a, 3b and 3c. To this effect, it is necessary to loosen the bearing plate 30 in order to clear the hard part 12 of the permanent structure created in the malleable plate 18. The permanent structure has a periodicity similar to that of the geometrical shut-off element, which allows moving the hard part 12 in relation to the malleable plate 18 of an integer period P, the hard part 12 being able to be replaced in a staggered manner in the malleable plate 18. The bearing plate 30 may hence be retightened to maintain this new position.

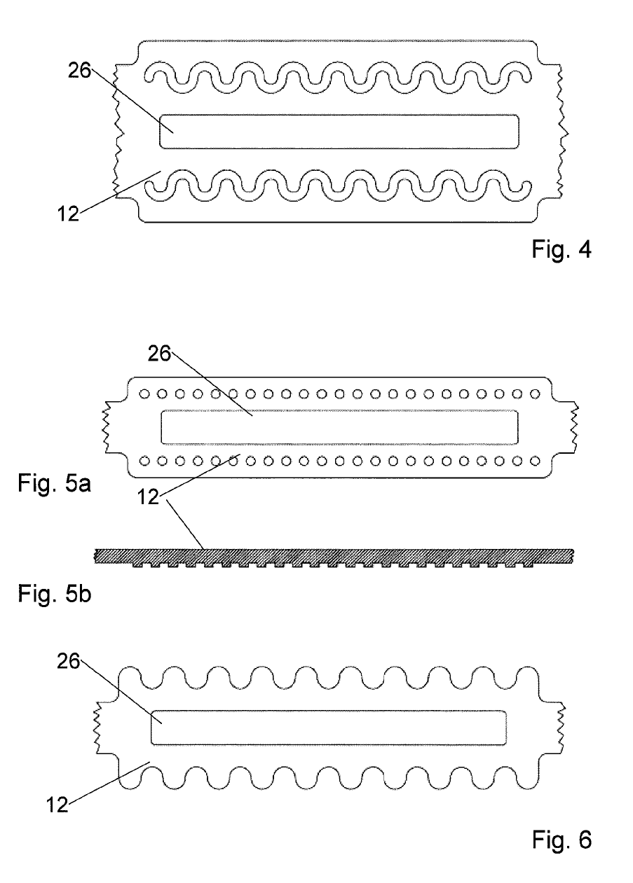

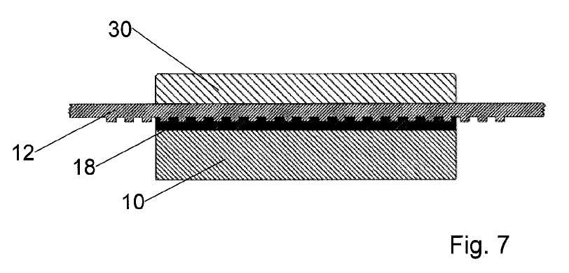

FIGS. 4, 5 and 6 propose alternatives to identical elements arranged periodically. In FIG. 4, the identical elements are sinusoidal and are arranged in a continuous manner to form a continuous sinusoidal side. FIGS. 5a and 5b represent a succession of spikes, in this case circular, aligned at regular intervals. In FIG. 6, there are also sinusoidal elements but arranged at the circumference of the hard part 12. By way of illustration, the hard part in FIG. 5 is implemented in FIG. 7.

It is understandable that, in the case of a non-periodic arrangement of the geometrical shut-off element, the plate 18, once deformed, has a particularly precise positioning of the hard part 12, which may be removed and replaced with precision by making to cooperate the geometrical shut-off element of the hard part 12 and the structure of the malleable plate 18.

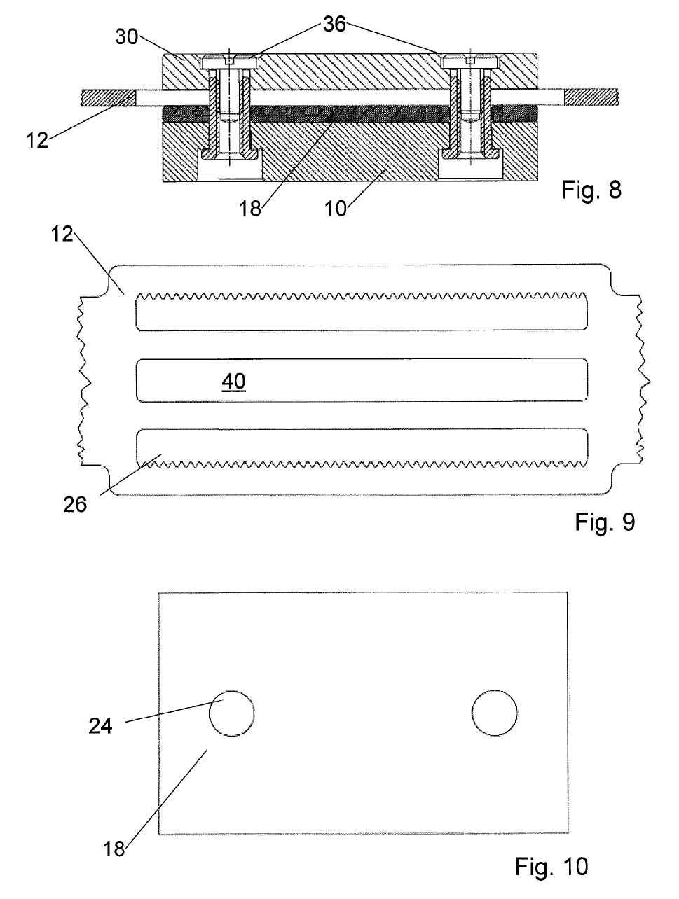

FIGS. 8, 9 and 10 represent an alternative embodiment as suggested above. The bearing plate 30 is attached to the support by special watchmaker clamps 36. FIG. 9 shows an interesting solution for the structure of the hard part. The oblong opening 26 is passed through by two uprights 38 parallel to the opening 26 and which define a groove 40 for allowing the passing through of the special watchmaker clamps 36, the walls of the groove being straight. This groove is advantageously used as positioning means of the hard part, leaving it only one degree of free movement. FIG. 10 shows a malleable plate 18 adapted to be implemented in this embodiment, with two orifices 24 for allowing the passing through of the special watchmaker clamps 36. It will be observed that the special watchmaker clamps ensure keeping tight the malleable plate 18 and that the rim 14 is hence removed. The use of special watchmaker clamps and the removal of the rim 14 may be implemented in other embodiments.

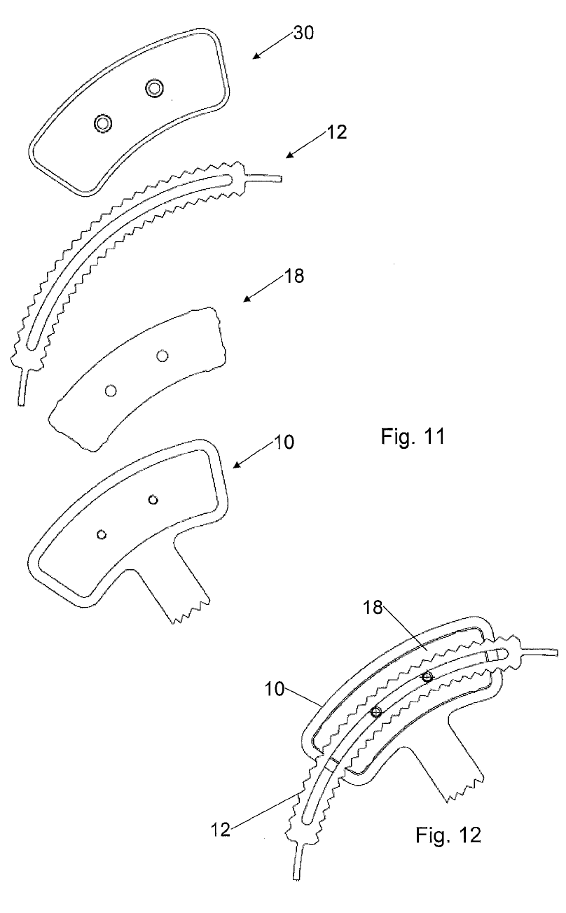

FIGS. 11 and 12 represent an embodiment of the invention, according to which the different elements are circular, the degree of free movement of the hard part 12 being defined by a circular curve. Similar elements to those proposed above are found in the first embodiment, bearing the same references. It will be observed that the geometrical shut-off element is, in this example, arranged on the larger external surfaces of the hard part 12. The geometrical shut-off element is also a regular toothing, allowing to reposition angularly the hard part 12 in relation to the support 10.

The elements described above may, in a particularly advantageous manner, be used in a method of fine tuning. Indeed, in the subject of watchmaking, some tunings cannot be carried out unless under real conditions, that is to say, the parts to be tuned must be assembled, making them work to assess the extent of tuning to be carried out, then disassemble the parts, operate on them, and reassemble them in order to undertake a functioning test. At times, such an operation may be very tedious.

Therefore, a package can be used such as proposed above to carry out an indexing or a fine tuning of the position of a part, taking the place of the hard part 12 in the above examples. Particularly, a support 10, a malleable plate 18, the part to be tuned with a geometrical shut-off element, preferably non-periodic, and a support plate 30 are made available. These various elements are assembled as above, but without tightening the bearing plate 30. Specifically, the bearing plate 30 is assembled so as to exert a pressure resulting in frictional forces among the various elements of the assembly, but the exerted force is lower than the limit of plastic deformation of the malleable plate. In practice, the bearing plate allows to keep by rubbing the various elements, but nevertheless without deforming permanently the malleable plate 18. The exercised maintaining is sufficient to test the function to be tuned. Should the test be inconclusive, it is enough to loosen slightly the bearing plate 30 in order to reposition the part to be tuned, retighten to obtain the maintaining by friction of the elements and test once again the function. When the test is successful, the bearing plate 30 may then be fully tightened so as to plastically deform the malleable plate 18. This operation is carried out without moving the part to be tuned and without losing the tuning. Furthermore, it allows obtaining simultaneously, by deforming the malleable plate, a positioning index of the part, particularly reliable and accurate.

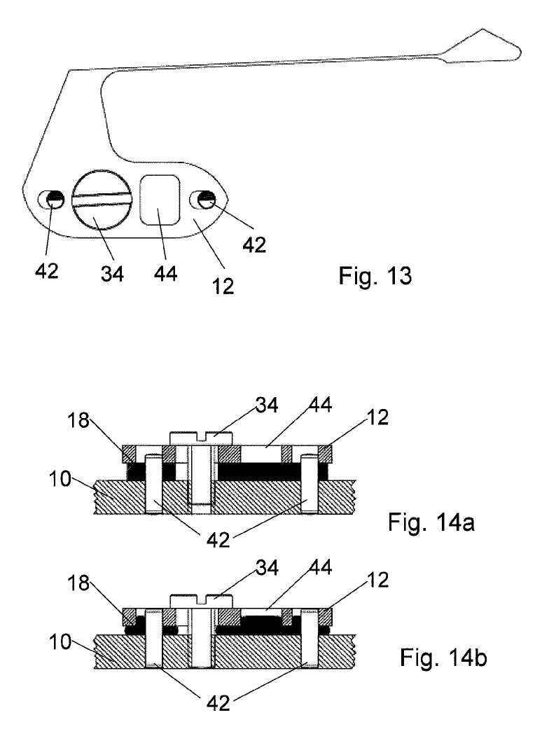

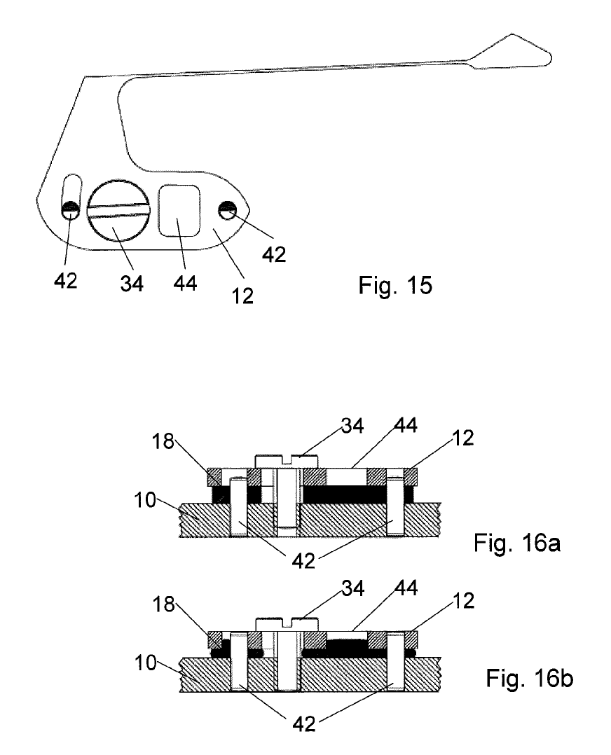

FIGS. 13 and 15 show jumpers that may be used as a part 12, the position of which is to be tuned. FIGS. 14a and 14b, on one hand, and FIGS. 16a and 16b, on the other hand, show the jumper of FIG. 13 and that of FIG. 15, in a tuning position for the Figures indexed a, and in the final position for Figures indexed b. FIGS. 13 and 14 relate to a jumper the position of which is tuned according to a longitudinal axis. The jumper is guided by two pins 42 cooperating with oblongs, serving as positioning means. FIGS. 15 and 16 relate to a jumper the position of which is tuned according to a circular curve. The jumper is also guided by two pins 42, one defining the centre of the circular curve, the other cooperating with a window positioned according to the circular curve.

It will be particularly observed that the geometrical shut-off element of the part 12 is made hollow and is formed by an opening 44 that it entails. The malleable plate 18 is not deformed in the Figures a, while in the Figures b, the part 18 has crept inside the opening 44 forming the geometrical shut-off element, but also, possibly, inside the oblongs and the circular window. It is also observed that, in this case, the screw tightens the part directly, without bearing plate.

It should be observed that the establishment of the permanent structure in the plate 18 by deformation may be carried out independently of the assembly of various elements. In particular, for parts the relative position of which is clearly defined and does not vary between two specimens of a mechanism, the deformation of the malleable part by a tool allowing to achieve in a precise manner the structure, will provide a particularly effective means of positioning, simple and precise of the hard part. It is therefore possible to obtain parts positioned perfectly and rapidly, even for large series. For such a possibility, deformation spaces are not essential.

It will be still observed that the deformation spaces, on the one hand, and the geometrical shut-off element, on the other hand, may be located on the upper and lower surfaces of the part to be positioned and not necessarily on the lateral surfaces. The deformation spaces may also result from the shape of the support 10, even from the part to be positioned and not from the malleable plate 18.

It may also be envisaged that the malleable plate 18 is attached to the support 10 in an independent step of the assembly. For example depending on the material chosen for its implementation, the plate 18 may be glued, welded, brazed, even deposited directly by galvanisation on the support. The plate term may therefore be interpreted in a non exhaustive manner.

1. A method for assembling a hard part made of a material the hardness of which is higher than 500 Vickers on a fixed support consisting in being:
equipped of a plate in malleable material arranged to be tightly positioned on the support,
equipped of a hard part further comprising a geometrical shut-off element positioned so as to be able to cooperate with said plate,
equipped of a clamping element for sandwiching between the latter and the support, the plate and the hard part,
the said method of assembly comprising the following steps:
arrange the plate tightly on the support,
arrange the hard part on the plate and position the latter by using positioning means by leaving only one to the hard part, said degree of free movement being in the plane defined by the hart part,
deform the plate so that the latter cooperates tightly with the geometrical shut-off element of the hard part,
position and secure the clamping element so as to sandwich the plate and the hard part between said clamping element and the support.

2. The method of claim 1, wherein the support, the malleable plate, the hard part and clamping element are sized so as to define deformation spaces for the malleable plate within which it can be deformed.

3. The method of claim 2, wherein said support is equipped with a rim defining a housing of L×l×h dimensions, and in that the plate is sized so as to be positioned tightly in the said housing.

4. The method of claim 3, wherein the plate is mechanically deformed and in that the plate has a thickness e>h.

5. The method of claim 1, wherein the plate is thermally deformed.

6. The method of claim 2, wherein the plate is thermally deformed.

7. The method of claim 3, wherein the plate is thermally deformed.

8. A method for assembling a hard part made of a material the hardness of which is higher than 500 Vickers on a fixed support consisting in being:
equipped of a plate in malleable material arranged to be tightly positioned on the support,
equipped of a hard part further comprising a geometrical shut-off element positioned so as to be able to cooperate with said plate,
equipped of a clamping element for sandwiching between the latter and the support, the plate and the hard part,
the said method of assembly comprising the following steps:
arrange the plate tightly on the support,
arrange the hard part on the plate and position the latter by using positioning means by leaving only one degree of free movement to the hard part,
deform the plate so that the latter cooperates tightly with the geometrical shut-off element of the hard part,
position and secure the clamping element so as to sandwich the plate and the hard part between said clamping element and the support.

9. The method of claim 5, wherein the plate is mechanically deformed.

10. The method of claim 5, wherein the plate is thermally deformed.

11. The method according to claim 1, wherein the geometrical shut-off element is constituted by a series of identical elements arranged periodically according to a period P on the circumference of the hard part, allowing a repositioning of the hard part on the plate after deformation.

12. The method of claim 1, wherein the geometrical element is arranged on at least one of the lateral surfaces of the hard part.

13. The method of claim 1, wherein the various elements are directed according to a longitudinal right axis A-A.

14. The method of claim 1, wherein the various elements are directed according to a circular curve.

15. A method of indexing of a hard part made of a material the hardness of which is higher than 500 Vickers, in relation to a support, comprising the steps of the method according to claim 8, characterised in that it comprises, furthermore, at least the following steps:
free the hard part,
move the hard part in relation to the support to a distance equal to an integer period P,
attach again the hard part by means of the clamping member so as to sandwich the plate and the hard part between the clamping member and the support.

16. The method of claim 15, wherein the hard part has at least one passing through oblong opening, and in which the clamping member is a bearing plate attached to the support by at least two screws passing through the opening.

17. A method of indexing of a part to be positioned in relation to a support, consisting in being:
equipped of a plate in malleable material arranged to be tightly positioned on the support,
equipped of a part to be positioned, comprising positioning means to be positioned at least partially opposite said plate, the hard part comprising furthermore a geometrical shut-off element positioned so as to be able to cooperate with the said plate,
equipped of a clamping member for sandwiching between the latter and the support, the plate and the part,
said method of indexing comprising the following steps:
arrange tightly the plate on the support,
arrange the said part on the plate and position the latter with the positioning means,
deform the plate so that the latter cooperates tightly with the geometrical shut-off element of the hard part,
position the clamping member so as to sandwich the plate and the said part between said clamping member and the support, so as to exert a pressure resulting in friction forces between the support, the plate, the said part and the clamping element, the exerted force being lower than the limit of plastic deformation of the malleable plate,
test the positioning of the said part,
should the test be negative, loosen the clamping member and reposition the said part to be tuned, retighten for maintaining by friction the elements and retest the positioning of the said part,
should the test be positive, fully tighten the clamping member so as to plastically deform the malleable plate.

18. The method according to claim 2, wherein the geometrical shut-off element is constituted by a series of identical elements arranged periodically according to a period P on the circumference of the hard part, allowing a repositioning of the hard part on the plate after deformation.

19. The method according to claim 3, wherein the geometrical shut-off element is constituted by a series of identical elements arranged periodically according to a period P on the circumference of the hard part, allowing a repositioning of the hard part on the plate after deformation.

20. The method according to claim 4, wherein the geometrical shut-off element is constituted by a series of identical elements arranged periodically according to a period P on the circumference of the hard part, allowing a repositioning of the hard part on the plate after deformation.
